(19) United States
(12) Patent Application Publication
(10) Pub. No.: US 2017/0094742 A1
(43) Pub. Date: Mar. 30, 2017

(54) DIMMER, DETECTOR, LIGHTING CONTROL SYSTEM, CONTROLLER, AND APPARATUS CONTROL SYSTEM

(71) Applicant: MINEBEA CO., LTD., Kitasaku-gun (JP)

(72) Inventors: Yoshihiro NAKAMURA, FUKUROI-SHI (JP); Kohei NISHIBORI, IWATA-SHI (JP)

(21) Appl. No.: 15/270,873

(22) Filed: Sep. 20, 2016

(30) Foreign Application Priority Data
Sep. 28, 2015 (JP) 2015-189173

(51) Int. Cl. H05B 33/08; H05B 37/02

(52) U.S. Cl. CPC H05B 33/0854; H05B 37/0272; H05B 37/0227; H05B 37/0218; H05B 33/0815

(57) ABSTRACT

A dimmer includes: a reception unit that performs communication through a wireless mesh network; a signal analysis unit that extracts PWM information based on a dimming instruction signal received by the reception unit; a PWM instruction signal generation unit that generates a PWM instruction signal based on the PWM information; and a PWM signal generation unit that generates a PWM signal for modulating brightness of a light source according to the PWM instruction signal.

### BACKGROUND OF THE DISCLOSURE

1. Field of the Invention

The present invention relates to a dimmer that wirelessly receives an amount of operation to produce a pulse width modulation (PWM) signal based on information on the received amount of operation, the dimmer, a detector, a lighting control system, a controller, and an apparatus control system for instructing an amount of operation wirelessly.

2. Description of the Related Art

Recently, a system capable of performing centralized control of a plurality of lighting appliances has been proposed. For example, control standards of lighting called digital addressable lighting interface (DALI) capable of performing centralized control by connecting a plurality of lighting appliances and a master controller by wire are popularized.

This system is provided with a PWM dimming control device that outputs a dimming instruction signal (PWM signal) to a light-emitting diode (LED) driving device according to an operation amount of a user, and can easily and suitably control lighting. However, in a system for controlling lighting appliances by wire like the DALI standards, an introduction cost for an existing lighting appliance is high, and it is not practical. Accordingly, there is proposed a system for controlling lighting appliances wirelessly. An example of such system is disclosed in JP-A-2006-140764. Thereby, the lighting appliances can be intensively controlled without control lines.

In the paragraph [0006] of JP-A-2006-140764, it is described to “provide a wireless communication device and a dimming control system enabling transmission of a control signal as well as transmission of monitoring data using a set of wireless devices without making a communication speed high.”

When configuring the dimming control system, an introduction cost of the system and expandability of the system should be considered. For example, the lighting appliance includes a light source including an LED or the like and a light source driver for driving the light source. The light source driver is controlled based on a dimming instruction signal received wirelessly, and performs dimming control on optical output of the light source. Here, a product in which the light source driver in which a mode of the dimming instruction signal input into the light source driver corresponds to a PWM mode has relatively much lighting output compared to a light source driver which has another mode is distributed to the market, and can be introduced inexpensively. That is, if a system converts the dimming instruction signal received by the wireless device into a PWM signal and then inputs the PWM signal into the light source driver, the introduction cost can be suppressed, and the system can be easily configured.

Like the configuration described in JP-A-2006-140764, in a wireless network in which a wireless master device and a plurality of wireless slave devices are connected in a relation of 1 to 1, a case in which a light is newly added is considered. In this case, if the wireless slave devices should be installed within a radio accessible range of the wireless master device, the communication can be performed. For example, there is a need to replace the wireless master device with a wireless device having a wide radio accessible range or to increase the number of wireless master devices, and expandability is low.

### SUMMARY OF THE INVENTION

One of objects of the present invention is to provide a dimmer, a detector, a lighting control system, a controller, and an apparatus control system, which are easily configurable and have high expandability.

According to an illustrative embodiment of the present invention, there is provided a dimmer including: a reception unit that performs communication through a wireless mesh network; a signal analysis unit that extracts PWM information based on a dimming instruction signal received by the reception unit; a PWM instruction signal generation unit that generates a PWM instruction signal based on the PWM information; and a PWM signal generation unit that generates a PWM signal for modulating brightness of a light source according to the PWM instruction signal.

According to another illustrative embodiment of the present invention, there is provided a detector including: a detection unit that detects environment information that is at least presence or absence of a human or ambient illuminance; a signal generation unit that generates a dimming instruction signal for a dimmer modulating brightness of a light source based on the environment information; and a transmission unit that performs communication on the dimmer through a wireless mesh network.

According to another illustrative embodiment of the present invention, there is provided a lighting control system including: a control device configured to include a transmission unit for transmitting a control signal through a wireless mesh network; a plurality of dimmers configured to output a PWM signal based on the control signal; and two or more lighting appliances operated to modulate brightness according to the PWM signal, wherein the transmission unit selects one of the dimmers as a bridge device based on radio field strengths received from the plurality of dimmers, and communicates with the other dimmers via the one selected dimmer, and wherein the transmission unit, when the radio field strength received from the one of the dimmers that is the bridge device is equal to or less than a predetermined value, re-selects another one of the dimmers as a bridge device based on the radio field strength received from each of the plurality of dimmers.

According to another illustrative embodiment of the present invention, there is provided a controller including: a reception unit that performs communication through a wireless mesh network; a signal analysis unit that extracts control information based on a control instruction signal received by the reception unit; an operation instruction signal generation unit that generates an operation instruction signal based on the control information; and a drive signal generation unit that generates a drive signal for driving an apparatus according to the operation instruction signal.

According to another illustrative embodiment of the present invention, there is provided an apparatus control system including: a control device configured to include a transmission unit for transmitting a control signal through a wireless mesh network; a plurality of controllers configured to output a drive signal based on the control signal; and two or more apparatuses that operates in accordance with the drive signal, wherein the transmission unit selects one of the controllers as a bridge device based on radio field strengths received from the plurality of controllers, and communicates with the other controllers via the one selected controller, and wherein the transmission unit, when the radio field strength received from the one of the controllers that is the bridge device is equal to or less than a predetermined value, re-selects another one of the controllers as a bridge device based on the radio field strengths received from the plurality of controllers.

### BRIEF DESCRIPTION OF THE DRAWINGS

In the accompanying drawings:

FIG. 1 is a configuration view of a lighting control system in a first embodiment;

FIG. 2 is a block diagram of each device included the lighting control system;

FIG. 3 is a block diagram illustrating a configuration of a wireless module;

FIG. 4 is a sequence diagram illustrating an operation of registering an apparatus;

FIG. 5 is a sequence diagram illustrating an operation of deregistering an apparatus;

FIG. 6 is a sequence diagram illustrating an automatic bridge switching operation;

FIG. 7 is a sequence diagram illustrating a control operation of a bridge device;

FIG. 8 is a sequence diagram illustrating a control operation of a normal device;

FIG. 9 is a sequence diagram illustrating a group registration operation;

FIG. 10 is a sequence diagram illustrating a group control operation and an individual control operation;

FIGS. 11A and 11B are views illustrating screens for the group control and the individual control;

FIG. 12 is a flow chart illustrating a process during group selection;

FIG. 13 is an external appearance view of a moving light and a control terminal in a second embodiment;

FIG. 14 is a block diagram illustrating a configuration of the wireless module;

FIGS. 15A and 15B are views illustrating screens for the group control and the individual control; and

FIG. 16 is a flow chart illustrating a process during the group selection.

### DETAILED DESCRIPTION

Hereinafter, embodiments for carrying out the invention will be described with reference to each drawing.

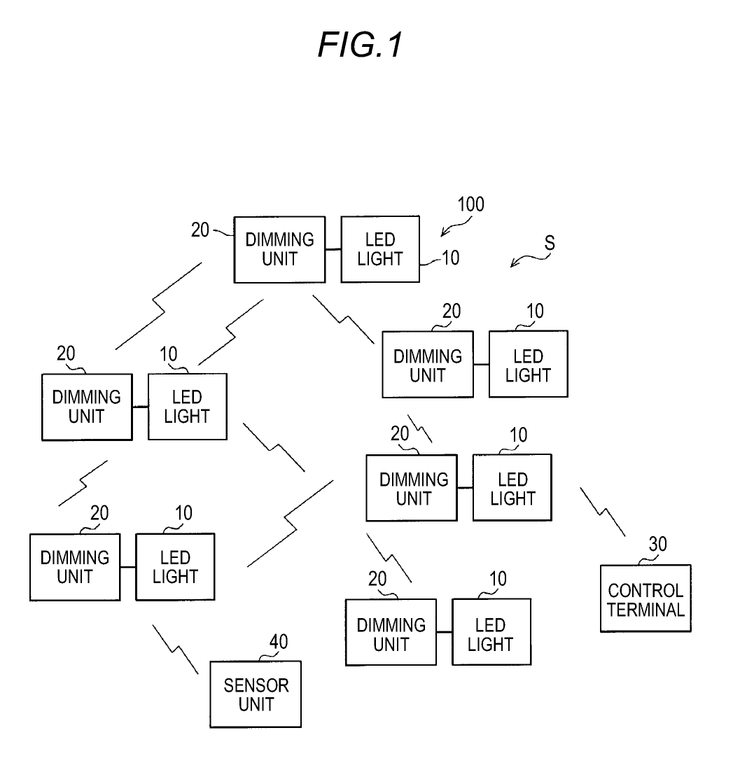

FIG. 1 is a configuration view of a lighting control system S in a first embodiment.

The lighting control system S is configured to include a lighting system 100 that is a combination of a plurality of dimming units (dimmers) 20 and LED lights 10 (an example of a lighting appliance), a control terminal 30 (an example of a control device), a sensor unit 40 (an example of a detector). The lighting control system S may be provided with both or one of the control terminal 30 and the sensor unit 40, and is not limited thereto.

The dimming units 20 and the sensor unit 40 capable to be connected with one another based on a mesh network technology using Bluetooth Smart (registered trademark). This mesh network technology is, for instance, CSRmesh (registered trademark), and is technology in which communication nodes disposed in a mesh shape perform communication in a relay form one after another. This can expand a communication arrival distance over one wireless communication link. In FIG. 1, a wireless mesh is indicated by zig-zag lines.

In the mesh network technology, the control terminal establishes connection (bridge connection) with one arbitrary unit at first. The relevant unit is called a bridge device. Transmission information from the control terminal is transmitted to the bridge device, and transmission from the bridge device to each unit is performed. A message from each unit to the control terminal is transmitted to the bridge device, and transmitted from the bridge device to the control terminal. Even if there occurs a unit that is not used by malfunction or the like, the message can be transmitted to a destination via another unit. When the bridge device is malfunctioning, the control terminal establishes bridge connection with an arbitrary unit other than the malfunctioning unit.

The control terminal 30 installs a dedicated application of the lighting control system S (for example, the control terminal is an iPhone (registered trademark) or an iPad (registered trademark) made by Apple, the control terminal downloads the dedicated application from an Apple store (registered trademark) and then installs it). The control terminal 30 transmits a dimming instruction signal corresponding to an amount of operation of a user to each of the dimming units 20 by the Bluetooth Smart (registered trademark). The sensor unit 40 transmits an ON/OFF command or an illuminance value command (an example of the dimming instruction signal) according to a result detected by a sensor to each of the dimming units 20 by the Bluetooth Smart (registered trademark).

The dimming units 20 are connected to the respective LED lights 10, and output PWM signal PWMs to the LED lights 10 to instruct modulation in brightness. The LED lights 10 perform dimming on light sources according to the PWM signal PWMs output by the dimming units 20. The control terminal 30 receives the ON/OFF command or the illuminance value command according to the result detected by the sensor of the sensor unit 40, and can monitor the ON/OFF command or the illuminance value command.

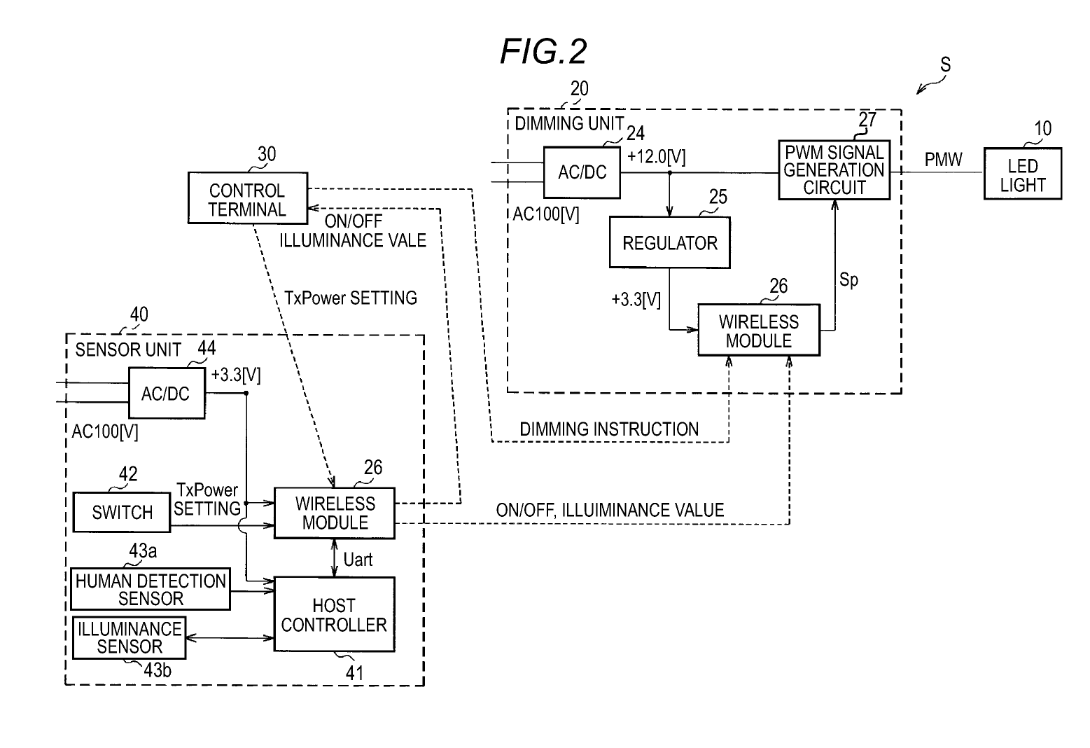

FIG. 2 is a block diagram of each device included the lighting control system S.

The LED light 10 is provided with a light source driving device (not illustrated) and an LED light source, and performs illumination under the control of a modulation in brightness based on the PWM signal PWM from the dimming unit 20.

The dimming unit 20 is provided with an AC/DC converter 24 that converts alternating current 100 V into direct current 12 V, a regulator 25 that steps down the direct current 12 V to +3.3 V, a wireless module 26 that is driven with the direct current 3.3 V, and a PWM signal generating circuit 27 that generates a PWM signal PWM from the direct current 12 V and a PWM instruction signal Sp. The PWM signal generating circuit 27 includes a switch element, and controls ON/OFF of the switch element according to the PWM instruction signal Sp, thereby converting the input direct current 12 V into the PWM signal PWM. The dimming unit 20 generates the PWM signal PWM based on a dimming command (an example of a dimming instruction signal). The wireless module 26 performs communication among the control terminal 30, the sensor unit 40, and the other dimming unit 20 through a wireless mesh network, and generates the PWM instruction signal Sp. The PWM signal generating circuit 27 generates the PWM signal PWM based on the PWM instruction signal Sp generated by the wireless module 26, and outputs it to the LED light 10. The state in which the dimming command is transmitted from the control terminal 30, and the ON/OFF command and the illuminance valve command are transmitted from the sensor unit 40 is illustrated in FIG. 1, but the invention is not limited thereto. Since driving power of the dimming unit 20 is low, the AC/DC converter 24 is not indispensable, and the dimming unit 20 may be driven by a battery.

The sensor unit 40 is provided with a host controller 41, an AC/DC converter 44 that converts alternating current 100 V into direct current 3.3 V, a switch 42, a wireless module 46 (an example of a transmission unit) and the host controller 41 (an example of a signal generation unit) that are driven with direct current 3.3 V, a human detection sensor 43a (an example of a detection unit), and an illuminance sensor 43b (an example of a detection unit). The wireless module 46 is provided with a central processing unit. A part of the central processing unit takes charge of a function of the host controller 41, and thereby the host controller 41 can be omitted.

The wireless module 46 and the host controller 41 are connected via a universal asynchronous receiver transmitter (UART). When receiving transmission power (TxPower) setting from the switch 42 or the control terminal 30, the host controller 41 or the wireless module 46 transmits an ON/OFF command or an illuminance valve command corresponding to this TxPower setting to the dimming units 20 or the control terminal 30.

The host controller 41 detects presence/absence of a person with the human detection sensor 43a and an ambient illuminance environment with the illuminance sensor 43b, and transmits an ON/OFF command or an illuminance valve command to the dimming units 20 or the control terminal 30 via the wireless module 46 based on these pieces of detection information. Since power consumption of the sensor unit 40 is small, the AC/DC converter 44 is not indispensable, and the sensor unit 40 may be driven by a battery.

The control terminal 30 is, for instance, a smartphone or a tablet terminal, and is provided with a touch panel display (not illustrated) and a communication part (an example of a transmission unit). This control terminal 30 installs a dedicated application, and thereby transmits a dimming command according to an operation of a user to the dimming units 20 through a wireless mesh network.

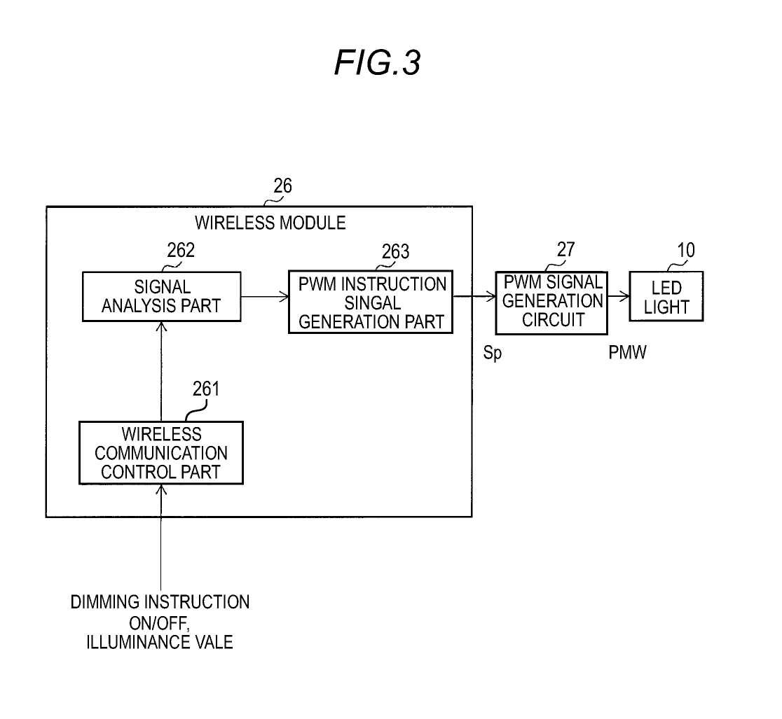

FIG. 3 is a block diagram illustrating a configuration of the wireless module 26.

The wireless module 26 illustrated in FIG. 3 is provided with a wireless communication control part 261, a signal analysis part 262 (an example of a signal analysis unit), and a PWM instruction signal generation part 263 (an example of a PWM instruction signal generation unit).

The wireless communication control part 261 is a reception unit for performing communication through a wireless mesh network (see FIG. 1). Here, receiving a dimming command, an ON/OFF command, and an illuminance valve command through the wireless mesh network is illustrated.

The signal analysis part 262 extracts PWM information based on the dimming command received by the wireless communication control part 261.

The PWM instruction signal generation part 263 generates a PWM instruction signal Sp for modulating the brightness of the light source according to the PWM information of the signal analysis part 262. The PWM signal generating circuit 27 (an example of a PWM signal generation unit) generates a PWM signal PWM based on this PWM instruction signal Sp, and supplies it to the LED lights 10.

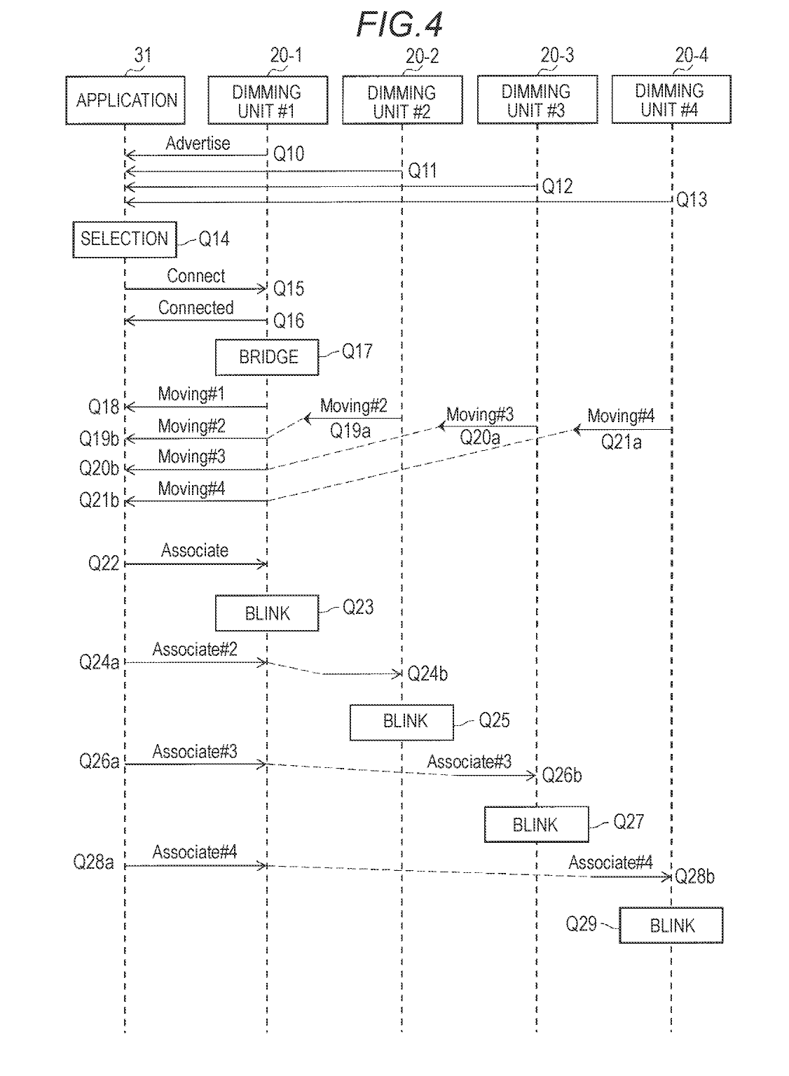

Hereinafter, an operation of the lighting control system S will be described according to sequence diagrams of FIGS. 4 to 10. Here, an application 31 refers to a application program executed by a CPU (not illustrated) of the control terminal 30. The lighting control system S is provided with four dimming units 20-1 to 20-4. When each of the dimming units 20-1 to 20-4 is not distinguished, it is simply described as dimming units 20. The sensor unit 40 shall not be included in the lighting control system S.

FIG. 4 is a sequence diagram illustrating an operation of registering an apparatus.

Sequences Q10 to Q17 illustrate an operation when the control terminal 30 (the application 31) selects a bridge device.

First, the control terminal 30 starts the application 31. At this point, each of the dimming units 20-1 to 20-4 periodically transmits “Advertise” (an advertisement packet) to advertise its own presence.

Depending on the execution of the application 31, the control terminal 30 receives “Advertise” from the dimming units 20-1 to 20-4 (sequences Q10 to Q13). The control terminal 30 determines which of the dimming units 20 has sufficient radio field strength, and selects one having highest radio field strength as the bridge device (sequence Q14). In the sequences of FIG. 1, the dimming unit 20-1 is selected.

The control terminal 30 (the application 31) transmits a “Connect” (connection) command to the selected dimming unit 20-1 (sequence Q15), and receives a “Connected” (connection completed) response from the dimming unit 20-1 (sequence Q16). Then, the control terminal 30 begins to operate this dimming unit 20-1 as the bridge device. Afterwards, the dimming unit 20-1 relays communication between the control terminal 30 and a device of another mesh network.

Sequences Q18 to Q29 illustrate an operation when the control terminal 30 (the application 31) registers the dimming units 20-1 to 20-4 as networks.

The control terminal 30 (the application 31) directly receives Moving#1 (an advertisement packet) from the dimming unit 20-1 (sequence Q18).

The dimming unit 20-2 transmits Moving#2 (an advertisement packet) through the wireless mesh network (sequence Q19a). The control terminal 30 receives Moving#2 transmitted by the dimming unit 20-2 via the dimming unit 20-1 using the application 31 (sequence Q19b).

The dimming unit 20-3 transmits Moving#3 (an advertisement packet) through the wireless mesh network (sequence Q20a). The control terminal 30 receives Moving#3 transmitted by the dimming unit 20-3 via the dimming unit 20-1 using the application 31 (sequence Q20b).

The dimming unit 20-4 transmits Moving#4 (an advertisement packet) through the wireless mesh network (sequence Q21a). The control terminal 30 receives Moving#4 transmitted by the dimming unit 20-4 via the dimming unit 20-1 using the application 31 (sequence Q21b).

The control terminal 30 (the application 31) directly transmits “Associate” (an association signal) to the dimming unit 20-1 (sequence Q22). Since the dimming unit 20-1 is registered as the network of this control terminal 30, the LED light 10 connected to the dimming unit 20-1 is turned on and blinked (turned on and off in a predetermined cycle) (sequence Q23). Thereby, a user who operates the control terminal 30 can visibly recognize which of the LED lights 10 is set as a target to be controlled.

The control terminal 30 (the application 31) transmits “Associate”#2 (an association signal) related to the dimming unit 20-2 via the dimming unit 20-1 (sequence Q24a). The dimming unit 20-2 receives “Associate”#2 through the wireless mesh network (sequence Q24b). Since the dimming unit 20-2 is registered as the network of this control terminal 30, the LED light 10 connected to the dimming unit 20-2 is turned on and blinked (turned on and off in a predetermined cycle) (sequence Q25).

The control terminal 30 (the application 31) transmits “Associate”#3 (an association signal) related to the dimming unit 20-3 via the dimming unit 20-1 (sequence Q26a). The dimming unit 20-3 receives “Associate”#3 through the wireless mesh network (sequence Q26b). Since the dimming unit 20-3 is registered as the network of this control terminal 30, the LED light 10 connected to the dimming unit 20-3 is turned on and blinked (turned on and off in a predetermined cycle) (sequence Q27).

The control terminal 30 (the application 31) transmits “Associate”#4 (an association signal) related to the dimming unit 20-4 via the dimming unit 20-1 (sequence Q28a). The dimming unit 20-4 receives “Associate”#4 through the wireless mesh network (sequence Q28b). Since the dimming unit 20-4 is registered as the network of this control terminal 30, the LED light 10 connected to the dimming unit 20-4 is turned on and blinked (turned on and off in a predetermined cycle) (sequence Q29).

When each of the dimming units 20 receives “Associate” related to itself, the LED light is not limited to being blinked (turned on and off in a predetermined cycle), but may be turned on in any pattern in which a user can visibly recognize, such as fading in or fading out.

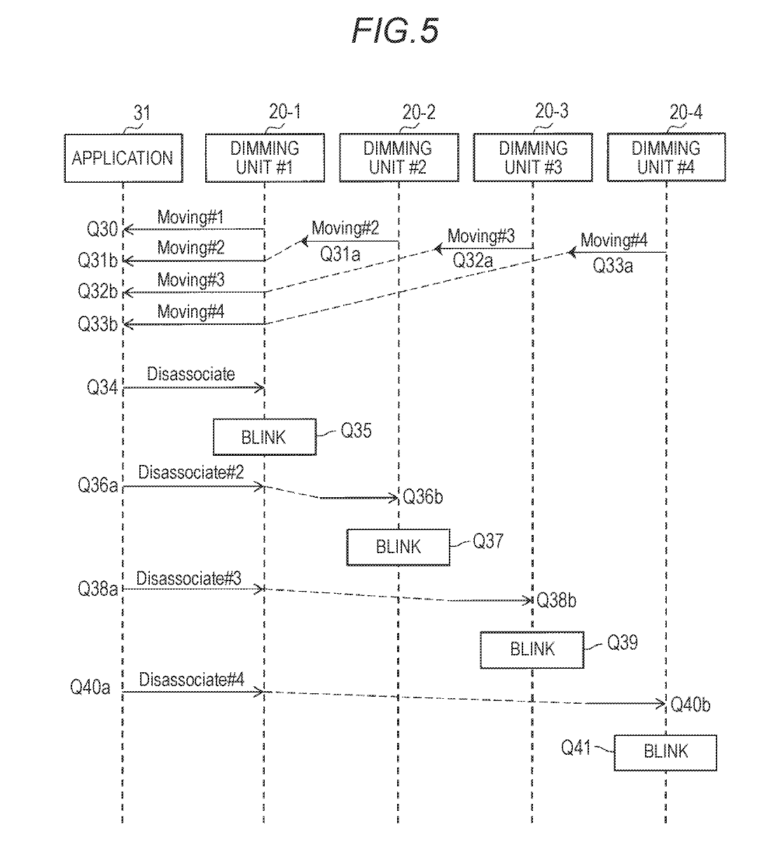

FIG. 5 is a sequence diagram illustrating an operation of deregistering an apparatus.

Operations of sequences Q30 to Q33b are the same as those of the sequences Q18 to Q21b illustrated in FIG. 4.

Sequences Q34 to Q41 illustrate an operation when the control terminal 30 (the application 31) deregisters the dimming units 20-1 to 20-4 from a network.

The control terminal 30 (the application 31) directly transmits “Disassociate” (a disassociation signal) to the dimming unit 20-1 (sequence Q34). Since the dimming unit 20-1 is released from the network of this control terminal 30, the LED light 10 connected to the dimming unit 20-1 is blinked (turned on and off in a predetermined cycle), and then is turned off (sequence Q35). Thereby, a user who operates the control terminal 30 can visibly recognize which of the LED lights 10 is released from the target to be controlled.

The control terminal 30 (the application 31) transmits “Disassociate”#2 (a disassociation signal) related to the dimming unit 20-2 via the dimming unit 20-1 (sequence Q36a). The dimming unit 20-2 receives “Disassociate”#2 through the wireless mesh network (sequence Q36b). Since the dimming unit 20-2 is released from the network of this control terminal 30, the LED light 10 connected to the dimming unit 20-2 is blinked (turned on and off in a predetermined cycle), and then is turned off (sequence Q37).

The control terminal 30 (the application 31) transmits “Disassociate”#3 (a disassociation signal) related to the dimming unit 20-3 via the dimming unit 20-1 (sequence Q38a). The dimming unit 20-3 receives “Disassociate”#3 through the wireless mesh network (sequence Q38b). Since the dimming unit 20-3 is released from the network of this control terminal 30, the LED light 10 connected to the dimming unit 20-3 is blinked (turned on and off in a predetermined cycle), and then is turned off (sequence Q39).

The control terminal 30 (the application 31) transmits “Disassociate”#4 (a disassociation signal) related to the dimming unit 20-4 via the dimming unit 20-1 (sequence Q40a). The dimming unit 20-4 receives “Disassociate”#4 through the wireless mesh network (sequence Q40b). Since the dimming unit 20-4 is released from the network of this control terminal 30, the LED light 10 connected to the dimming unit 20-4 is blinked (turned on and off in a predetermined cycle), and then is turned off (sequence Q41).

When each of the dimming units 20 receives “Disassociate” related to itself, the LED light is not limited to being blinked (turned on and off in a predetermined cycle), but may be turned on in any pattern (an example of a predetermined pattern) in which a user can visibly recognize, such as fading in or fading out. Moreover, when the LED light is turned on in a pattern different from a turn-on pattern when receiving “Associate”, a result of the operation can be definitely fed back to a user, which is preferable.

After the LED light is blinked (turned on and off in a predetermined cycle), the LED light may be continuously turned on without being turned off. Of course, each of the disassociated dimming units 20 can be associated again.

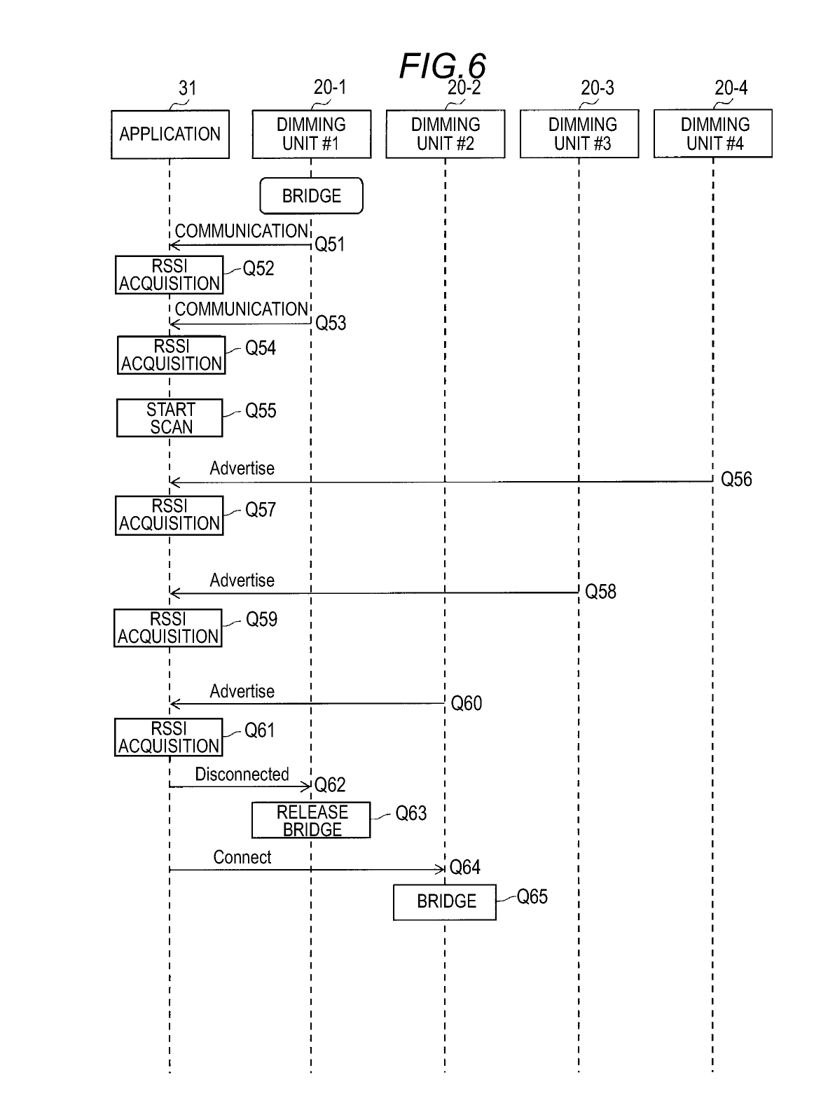

FIG. 6 is a sequence diagram illustrating an automatic bridge switching operation.

Here, the dimming unit 20-1 is operated as the bridge device related to the control terminal 30 (the application 31) in the beginning. The dimming unit 20-1 communicates with the control terminal 30 (the application 31) in a predetermined cycle (sequence Q51). The control terminal 30 (the application 31) acquires a received signal strength indication (RSSI) value related to this communication (sequence Q52). Thereby, the control terminal 30 (the application 31) can estimate a physical distance from a communication destination.

When a predetermined period has elapsed, the dimming unit 20-1 communicates with the control terminal 30 (the application 31) (sequence Q53), and the control terminal 30 (the application 31) acquires an RSSI value related to this communication (sequence Q54). At this point, when the RSSI value is not more than a predetermined value, the control terminal 30 (the application 31) starts to scan each device (sequence Q55).

The dimming units 20-1 to 20-4 regularly transmit “Advertise” to advertise their own presence.

The control terminal 30 receives “Advertise” from the dimming unit 20-4 (sequence Q56), and acquires an RSSI value (sequence Q57). The control terminal 30 receives “Advertise” from the dimming unit 20-3 (sequence Q58), and acquires an RSSI value (sequence Q59). The control terminal 30 receives “Advertise” from the dimming unit 20-2 (sequence Q60), and acquires an RSSI value (sequence Q61).

When the control terminal 30 (the application 31) determines that the RSSI value of the dimming unit 20-2 is greatest and exceeds a predetermined value, the control terminal 30 switches the bridge device.

The control terminal 30 (the application 31) transmits “Disconnect” to the dimming unit 20-1 (sequence Q62), and releases the dimming unit 20-1 from the bridge device (sequence Q63). Further, the control terminal 30 (the application 31) transmits “Connect” to the dimming unit 20-2 (sequence Q64), and selects the dimming unit 20-2 as the bridge device (sequence Q65). Thereby, the bridge device can always be an optimal device.

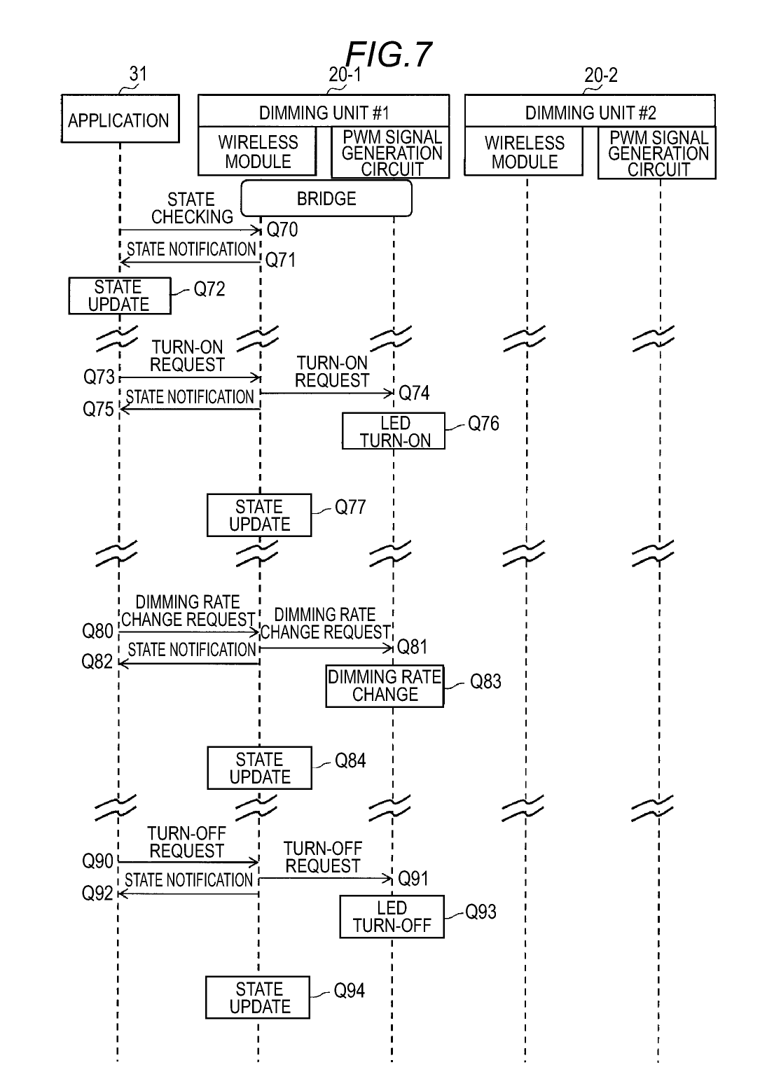

FIG. 7 is a sequence diagram illustrating a control operation of the bridge device.

Here, the dimming unit 20-1 is operated as the bridge device related to the control terminal 30 (the application 31). The control terminal 30 (the application 31) directly transmits a state checking command of the dimming unit 20-1 (sequence Q70), receives a state notification response (sequence Q71), and then updates state information of this dimming unit 20-1 (sequence Q72). The state information is, for instance, information about whether or not the LED light 10 is turned on, or a dimming rate of the LED light 10.

The control terminal 30 (the application 31) directly transmits a turn-on request command of the dimming unit 20-1 (sequence Q73). When the wireless module 26 of the dimming unit 20-1 receives the turn-on request command, the wireless module 26 performs a turn-on request (outputting a PWM instruction signal Sp based on a predetermined duty cycle) on the PWM signal generating circuit 27 (sequence Q74), and responds to a state notification for the control terminal 30 (the application 31) (sequence Q75). The light source of the LED light 10 is turned on in response to the turn-on request (sequence Q76). The wireless module 26 updates the state information of the PWM signal generating circuit 27 (sequence Q77).

The control terminal 30 (the application 31) directly transmits a dimming rate change request command of the dimming unit 20-1 (sequence Q80). When the wireless module 26 of the dimming unit 20-1 receives the dimming rate change request command, the wireless module 26 performs a dimming rate change request (outputting a PWM instruction signal Sp based on a predetermined duty cycle) on the PWM signal generating circuit 27 (sequence Q81), and responds to a state notification for the control terminal 30 (the application 31) (sequence Q82). The PWM signal generating circuit 27 changes a dimming rate of the LED light 10 (sequence Q83). The wireless module 26 updates the state information of the PWM signal generating circuit 27 (sequence Q84).

The control terminal 30 (the application 31) directly transmits a turn-off request command of the dimming unit 20-1 (sequence Q90). When the wireless module 26 of the dimming unit 20-1 receives the turn-off request command, the wireless module 26 performs a turn-off request (outputting a PWM instruction signal Sp based on a duty cycle in which the light source is turned off) on the PWM signal generating circuit 27 (sequence Q91), and responds to a state notification for the control terminal 30 (the application 31) (sequence Q92). The light source of the LED light 10 is turned off in response to the turn-off request (sequence Q93). The wireless module 26 updates the state information of the PWM signal generating circuit 27 (sequence Q94). The turn-off request on the PWM signal generating circuit 27 is performed by a method of setting an output port of the PWM instruction signal generation part 263 to be open, resulting in making a magnitude of the PWM instruction signal Sp into zero, and thereby turning off the light source, or a method of outputting a PWM instruction signal Sp based on a duty cycle in which the light source is turned off and thereby turning off the light source.

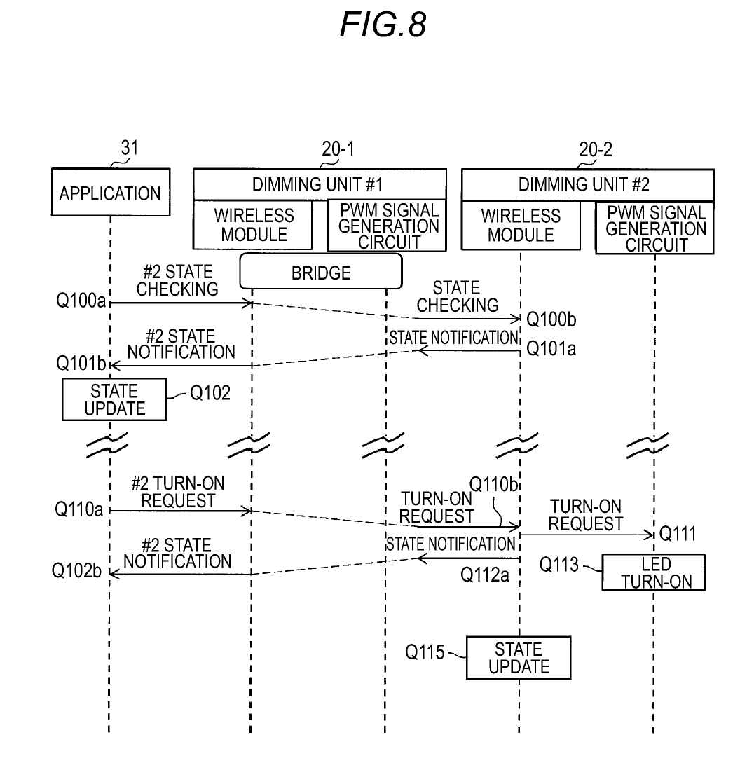

FIG. 8 is a sequence diagram illustrating a control operation of a normal device (a device other than a bridge device).

Here, the dimming unit 20-1 is operated as the bridge device related to the control terminal 30 (the application 31). The control terminal 30 (the application 31) transmits a state checking command of the dimming unit 20-2 via the dimming unit 20-1 (sequence Q100a). The wireless module 26 of the dimming unit 20-2 receives the state checking command of the dimming unit 20-2 through the wireless mesh network (sequence Q100b), and responds to a state notification through the wireless mesh network (sequence Q101a). The dimming unit 20-1 relays the state notification of the dimming unit 20-2 to the control terminal 30 (sequence Q101b). Thereby, the control terminal 30 updates the state information of the dimming unit 20-2 (sequence Q102).

Further, the control terminal 30 (the application 31) transmits a turn-on request command of the dimming unit 20-2 via the dimming unit 20-1 (sequence Q110a). When the wireless module 26 of the dimming unit 20-2 receives the turn-on request command of the dimming unit 20-2 through the wireless mesh network (sequence Q110b), the wireless module 26 performs a turn-on request (outputting a PWM instruction signal Sp based on a predetermined duty cycle) on the PWM signal generating circuit 27 (sequence Q111), and responds to a state notification for the control terminal 30 (the application 31) through the wireless mesh network (sequence Q112a). The dimming unit 20-1 relays the state notification of the dimming unit 20-2 to the control terminal 30 (sequence Q112b). Thereby, the control terminal 30 updates the state information of the dimming unit 20-2.

The light source of the LED light 10 is turned on in response to the turn-on request (sequence Q113). The wireless module 26 updates the state information (sequence Q115).

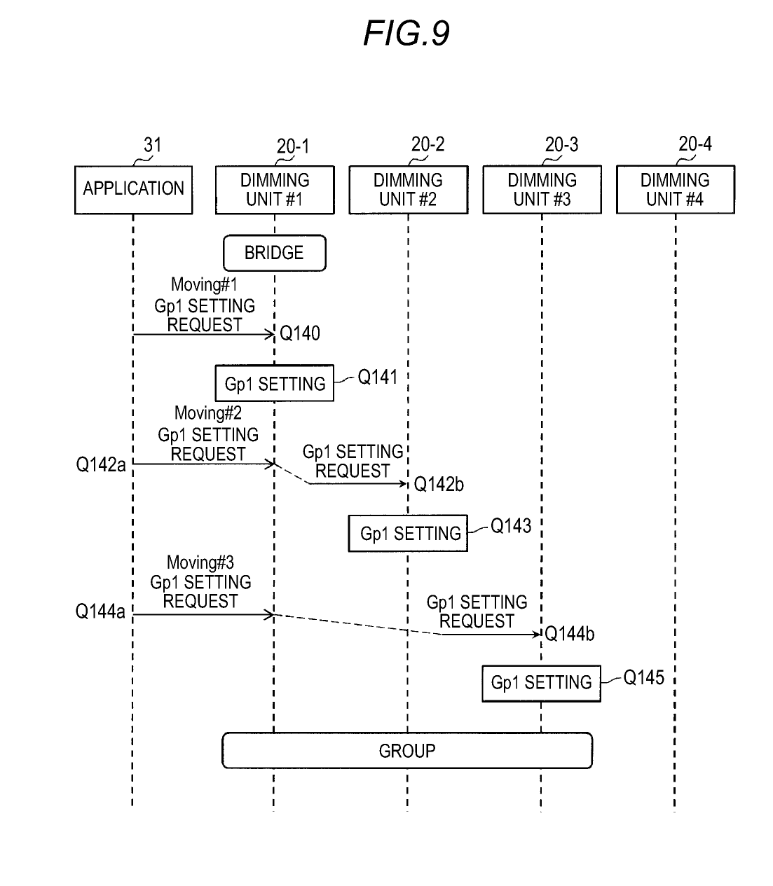

FIG. 9 is a sequence diagram related to group registration control.

As illustrated in FIG. 9, the dimming unit 20-1 is operated as the bridge device related to the control terminal 30 (the application 31).

The control terminal 30 (the application 31) transmits Moving#1 (a group setting request) related to the dimming unit 20-1 to the dimming unit 20-1 (sequence Q140). In FIG. 9, the group setting request is schematically described as “Gp1 setting request.” The dimming unit 20-1 directly receives Moving#1. The dimming unit 20-1 sets itself to be operated as group#1 of the network of this control terminal 30 (sequence Q141).

The control terminal 30 (the application 31) transmits Moving#2 (a group setting request) related to the dimming unit 20-2 via the dimming unit 20-1 (sequence Q142a). The dimming unit 20-2 receives Moving#2 through the wireless mesh network (sequence Q142b). The dimming unit 20-2 sets itself to be operated as group#1 of the network of this control terminal 30 (sequence Q143).

The control terminal 30 (the application 31) transmits Moving#3 (a group setting request) related to the dimming unit 20-3 via the dimming unit 20-1 (sequence Q144a). The dimming unit 20-3 receives Moving#3 through the wireless mesh network (sequence Q144b). The dimming unit 20-3 sets itself to be operated as group#1 of the network of this control terminal 30 (sequence Q143).

With this operation, the control terminal 30 (the application 31) can register the dimming units 20-1 to 20-3 for group#1.

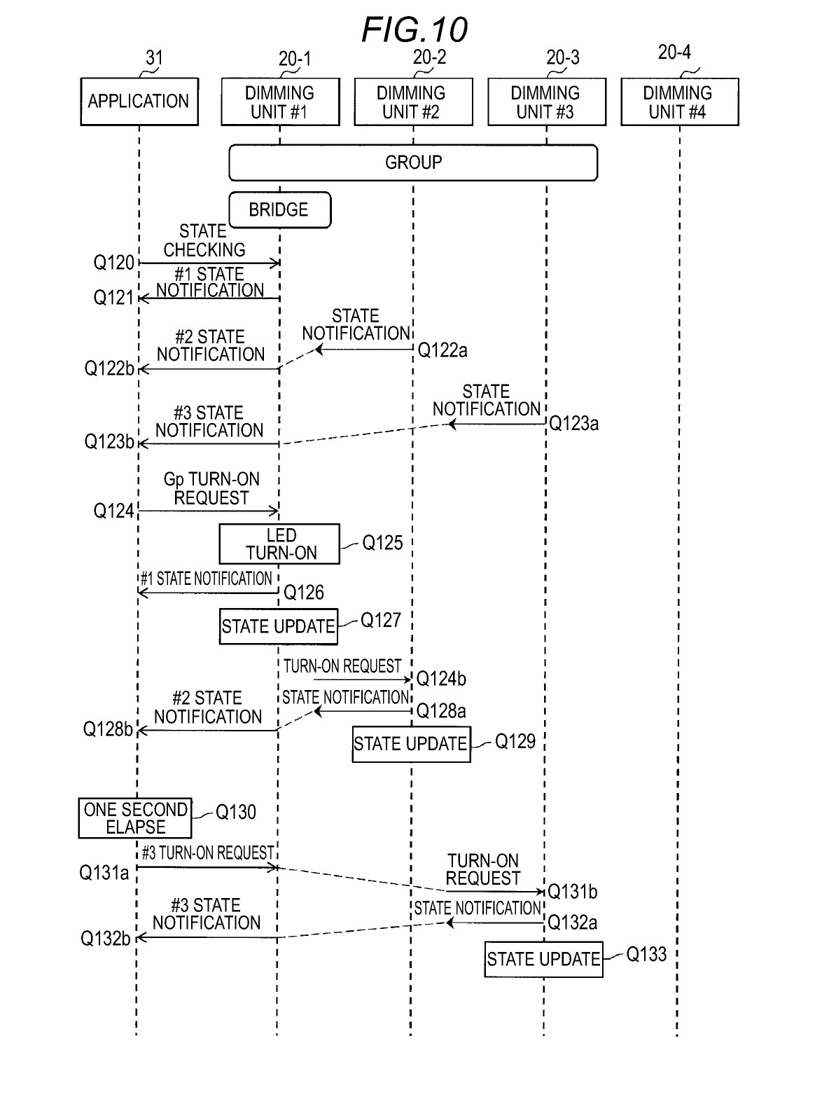

FIG. 10 is a sequence diagram illustrating a group control operation and an individual control operation.

Sequences Q120 to Q129 indicate a group control operation, and sequences Q130 to Q133 indicate an individual control operation in a retry. Here, the dimming unit 20-1 is operated as the bridge device related to the control terminal 30 (the application 31). The dimming units 20-1 to 20-3 are subjected to group registration.

The control terminal 30 (the application 31) transmits a group state checking command via the dimming unit 20-1 (sequence Q120).

The dimming unit 20-1 directly transmits a state notification to the control terminal 30 (sequence Q121).

The dimming unit 20-2 responds to a state notification for the control terminal 30 (the application 31) through the wireless mesh network (sequence Q122a). The dimming unit 20-1 relays the state notification of the dimming unit 20-2 to the control terminal 30 (sequence Q122b).

The dimming unit 20-3 responds to a state notification for the control terminal 30 (the application 31) through the wireless mesh network (sequence Q123a). The dimming unit 20-1 relays the state notification of the dimming unit 20-3 to the control terminal 30 (sequence Q123b).

Next, the control terminal 30 (the application 31) transmits a group turn-on request command via the dimming unit 20-1 (sequence Q124).

When the dimming unit 20-1 turns on the LED light 10 (sequence Q125) and directly transmits a state notification to the control terminal 30 (sequence Q126), the dimming unit 20-1 updates state information (sequence Q127).

When the dimming unit 20-2 receives the group turn-on request command (sequence Q124b), the dimming unit 20-2 turns on the LED light 10 (not illustrated), and then transmits a state notification to the control terminal 30 through the wireless mesh network (sequence Q128a), and updates the state information (sequence Q129). The dimming unit 20-1 relays the state notification of the dimming unit 20-2 to the control terminal 30 (sequence Q128b).

Here, the dimming unit 20-3 fails to receive the group turn-on request command, and one second has elapsed in this state (sequence Q130).

Since the control terminal 30 (the application 31) monitors the state notification of the dimming unit 20-3 and does not receive the state notification for a predetermined time, the control terminal 30 transmits (re-transmits) the turn-on request command of this dimming unit 20-3 via the dimming unit 20-1 (sequence Q131a). When the dimming unit 20-3 receives the turn-on request command through the wireless mesh network (sequence Q131b), the dimming unit 20-3 turns on the LED light 10 (not illustrated), and then transmits a state notification to the control terminal 30 through the wireless mesh network (sequence Q132a), and updates the state information (sequence Q133). The dimming unit 20-1 relays the state notification of the dimming unit 20-3 to the control terminal 30 (sequence Q132b). In this way, under group control, some of the dimming units 20 fail in the control. In this case, the dimming units 20 are controlled individually, and thereby it is possible to suppress an influence on the entire group.

With respect to retransmission processing of the dimming units 20 that fail in the control, when a message is transmitted the previously specified number of times of retransmission but does not return, the retransmission processing may be stopped, and display of, for instance, beyond the communication coverage may be performed on the control terminal 30. Thereby, communication traffic can be relieved.

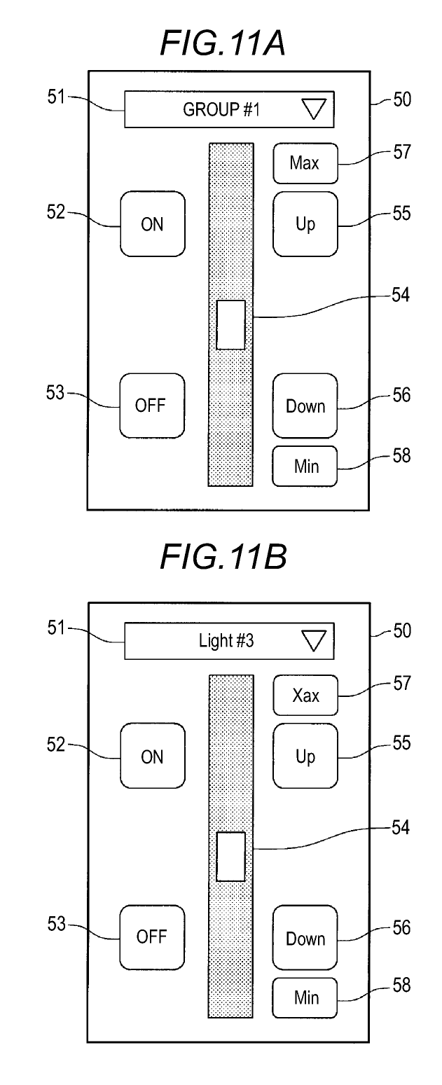

FIGS. 11A and 11B are views illustrating screens for group control and individual control.

FIG. 11A is a view illustrating a control screen 50 of a group in a dedicated application installed in the control terminal 30.

The control screen 50 has a selection combo box 51 displayed at an upper portion thereof, and a dimming slider 54 disposed at the center thereof in a longitudinal direction. An ON button 52 and an OFF button 53 are disposed on the left side of the control screen 50, and a Max button 57, an Up button 55, a Down button 56, and a Min button 58 are disposed in turn on the right side of the control screen 50.

The selection combo box 51 is a combo box for selecting a target to be controlled. Here, “group#1” is selected.

The dimming slider 54 is a slider that designates illuminance of the LED light 10. This dimming slider 54 is displayed based on a state notification of each of the dimming units 20.

The ON button 52 instructs turn-on of the LED light 10, and the OFF button 53 instructs turn-off of the LED light 10. The Max button 57 instructs maximum illuminance of the LED light 10, and the Min button 58 instructs minimum illuminance of the LED light 10. The Up button 55 instructs an increase in a predetermined value of illuminance, and the Down button 56 instructs a decrease in a predetermined value of illuminance.

FIG. 11B is a view illustrating a control screen 50 of an individual in the dedicated application installed in the control terminal 30.

The control screen 50 of the individual has a difference in that an individual device such as “Light#3 (Dimming unit#3)” is selected in a selection combo box 51. The control terminal 30 of the embodiment may select and control the dimming units 20 belonging to the entire group and the dimming units 20 of the individuals.

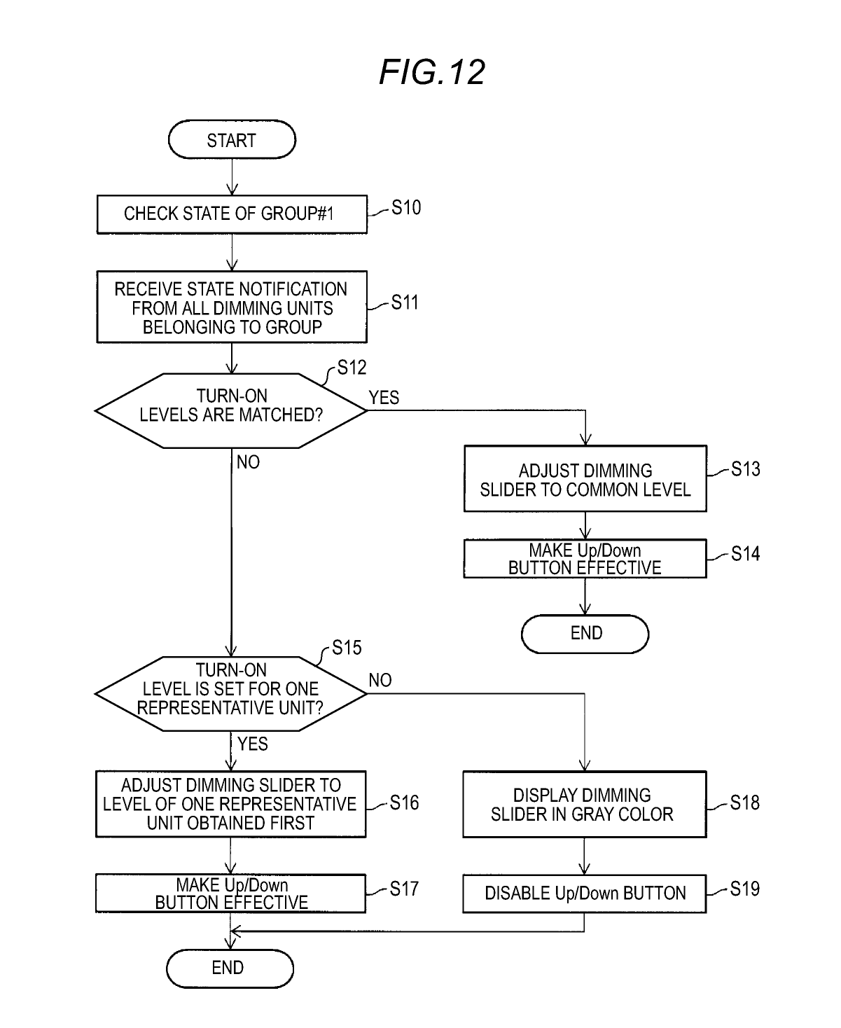

FIG. 12 is a flow chart illustrating a process during group selection.

The control terminal 30 (the application 31) checks a state of group#1 first (step S10), and receives state notifications from all of the dimming units 20 belonging to this group#1 (step S11).

The control terminal 30 (the application 31) determines whether or not turn-on levels of all of the dimming units 20 belonging to group#1 are matched with each other (step S12). If so, the control terminal 30 adjusts the dimming slider 54 to a common level (step S13), effectively displays the Up button 55 and the Down button 56 (step S14), and terminates the process of FIG. 12.

If the turn-on levels of all of the dimming units 20 belonging to group#1 are not matched with each other (No of step S12), the control terminal 30 (the application 31) inquires of a user whether or not the turn-on level is set for one representative unit obtained first (step S15). If so, the control terminal 30 adjusts the dimming slider 54 to the level of the one representative unit (step S16), effectively displays the Up button 55 and the Down button 56 (step S17), and terminates the process of FIG. 12.

If the turn-on level is not set for one representative unit obtained first (No of step S15), the control terminal 30 (the application 31) displays the dimming slider 54 in a gray color and disables it (step S18), disables the Up button 55 and the Down button 56 (step S19), and terminates the process of FIG. 12.

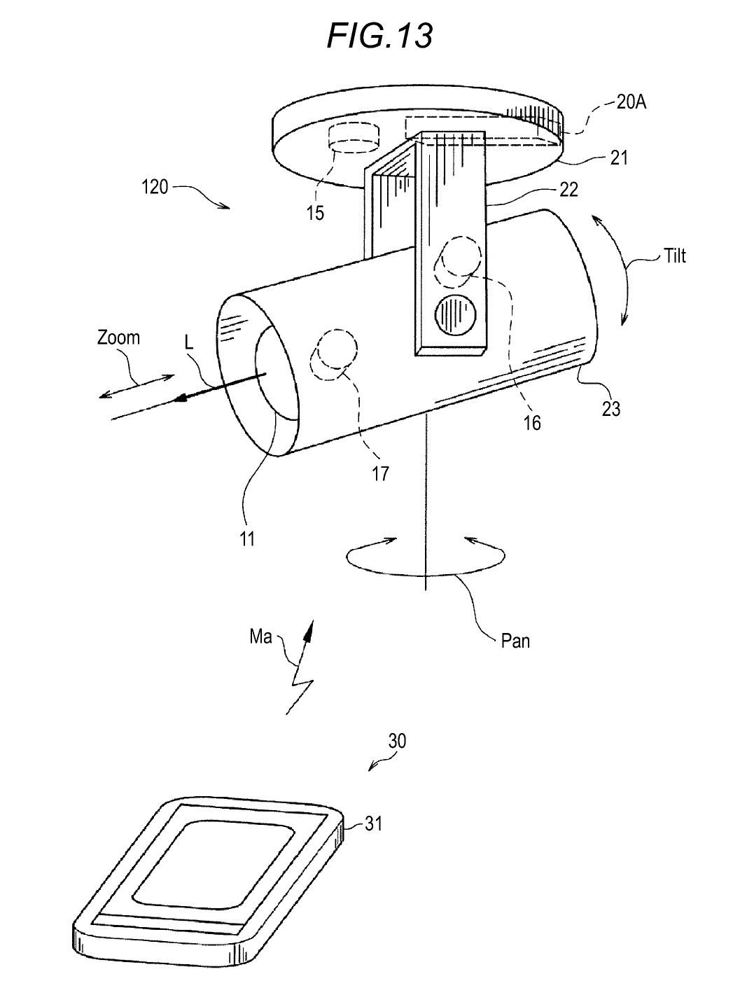

FIG. 13 is an external appearance view of a moving light and a control terminal in a second embodiment.

As illustrated in FIG. 13, a variable lighting system is configured to include a moving light 120 (an example of an apparatus that can drive a part), and a variable controller 20A. The moving light 120 is configured to include a clockwise/counterclockwise rotation part 21, an arm 22 that is fixed below this clockwise/counterclockwise rotation part 21, and a hood 23 that is held by this arm 22.

In the moving light 120, the clockwise/counterclockwise rotation part 21 is provided with a pan motor 15. The clockwise/counterclockwise rotation part 21 is connected to a fixing part of the ceiling, and is configured to be rotatable clockwise and counterclockwise by the pan motor 15. The clockwise/counterclockwise rotation part 21 can hold the arm 22, and pan a lighting direction of an LED 11 clockwise and counterclockwise by rotation of the pan motor 15.

The hood 23 is held by the arm 22, and is configured to be rotatable in a vertical direction by a tilt motor 16 mounted on the arm 22. The hood 23 can tilt the lighting direction of the LED 11 up and down by rotation of the tilt motor 16.

The hood 23 has the LED 11 stored therein, and is configured to allow a focal distance of the LED 11 to be adjusted by a focus motor 17 and a lens (not illustrated).

The control terminal 30 transmits a control signal instructing a movement operation of the relevant part to an apparatus that can drive a part, using an installed dedicated application. The control terminal 30 generates, for instance, a communication signal Ma for rotatably moving the LED 11, and transmits the generated communication signal Ma to a variable controller 20A of the moving light 120 using Bluetooth Smart (registered trademark).

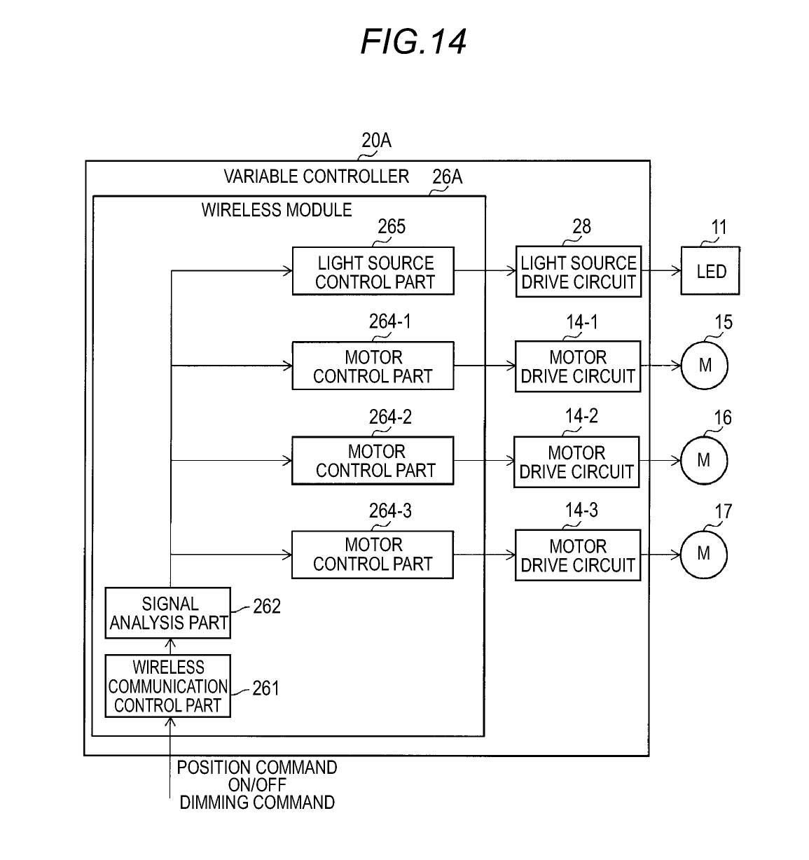

FIG. 14 is a block diagram illustrating a configuration of a wireless module 26A. The same symbols are given to the same elements as in the wireless module 26 illustrated in FIG. 3.

The wireless module 26A is provided with a light source control part 265 and motor control parts 264-1 to 264-3, and includes a wireless communication control part 261 and a signal analysis part 262 that are similar to those of the first embodiment.

The light source control part 265 generates a light source operation instruction signal (an example of an operation instruction signal) for driving the LED 11 according to light source control information (an example of control information) analyzed by the signal analysis part 262. A light source drive circuit 28 generates a light source drive signal (an example of a drive signal) based on this light source operation instruction signal, and drives the LED 11.

The motor control part 264-1 generates a pan motor operation instruction signal (an example of the operation instruction signal) for driving the pan motor 15 according to pan motor control information (an example of the control information) analyzed by the signal analysis part 262. A motor drive circuit 14-1 generates a pan motor drive signal (an example of a drive signal) based on this pan motor operation instruction signal, and drives the pan motor 15.

The motor control part 264-2 generates a tilt motor operation instruction signal (an example of the operation instruction signal) for driving the tilt motor 16 according to tilt motor control information (an example of the control information) analyzed by the signal analysis part 262. A motor drive circuit 14-2 generates a tilt motor drive signal (an example of the drive signal) based on this tilt motor operation instruction signal, and drives the tilt motor 16.

The motor control part 264-3 generates a focus motor operation instruction signal (an example of the operation instruction signal) for driving the focus motor 17 according to focus motor control information (an example of the control information) analyzed by the signal analysis part 262. A motor drive circuit 14-3 generates a focus motor drive signal (an example of the drive signal) based on this focus motor operation instruction signal, and drives the focus motor 17.

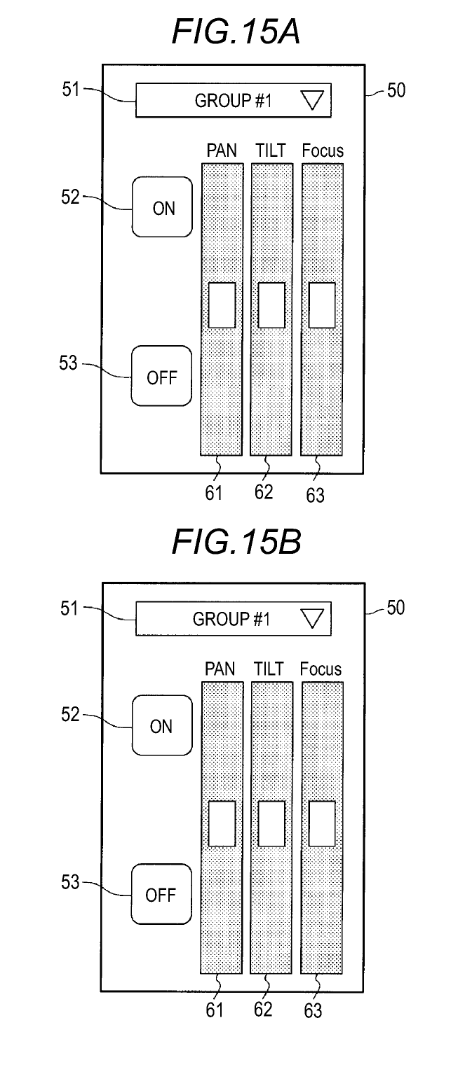

FIGS. 15A and 15B are views illustrating screens for group control and individual control.

FIG. 15A is a view illustrating a control screen 50 of a group in the control terminal 30.

The control screen 50 has a selection combo box 51 displayed at an upper portion thereof, and a pan slider 61, a tilt slider 62, and a focus slider 63 disposed from the center thereof to the right side thereof in a longitudinal direction. The pan slider 61, the tilt slider 62, and the focus slider 63 are generally called a position slider.

An ON button 52 and an OFF button 53 are disposed on the left side of the control screen 50.

The selection combo box 51 is a combo box for selecting a target to be controlled. Here, “group#1” is selected.

The pan slider 61, the tilt slider 62, and the focus slider 63 are sliders that designate a pan position, a tilt position, and a focus position of the LED 11, respectively. This dimming slider 54 is displayed based on the state notification from each of the variable controllers 20A. The ON button 52 instructs turn-on of the LED 11, and the OFF button 53 instructs turn-off of the LED 11.

FIG. 15B is a view illustrating a control screen 50 of an individual in the control terminal 30.

The control screen 50 of the individual has a difference in that an individual device such as “Light#3” is selected in a selection combo box 51, for example. The control terminal 30 of this embodiment may select and control the variable controllers 20A belonging to the entire group and the variable controllers 20A of the individuals.

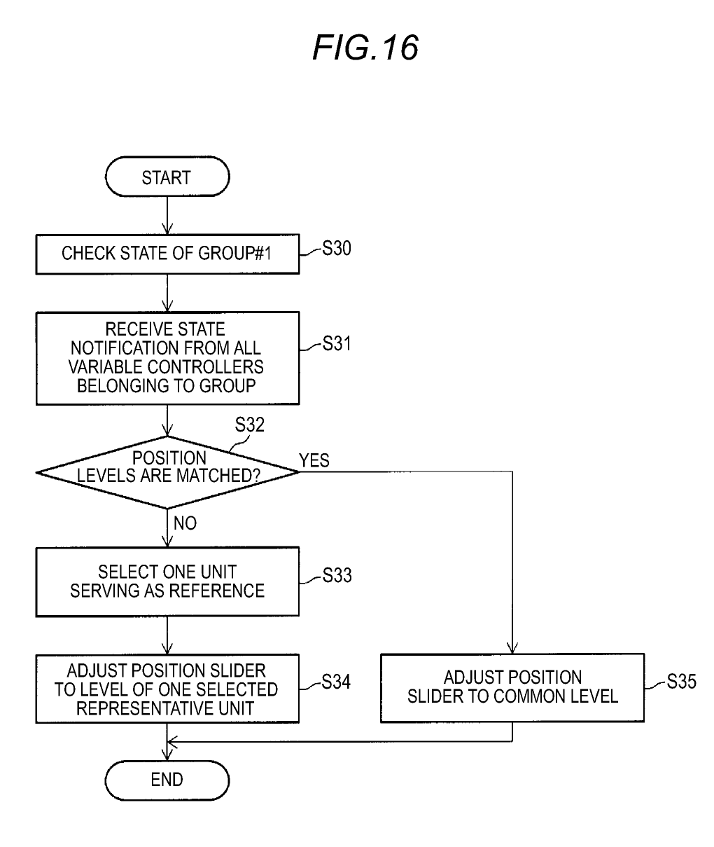

FIG. 16 is a flow chart illustrating a process during group selection.

The control terminal 30 (the application 31) checks a state of group#1 first (step S30), and receives a state notification from all of the variable controllers 20A belonging to this group#1 (step S31).

The control terminal 30 (the application 31) determines whether or not position levels of all of the variable controllers 20A belonging to group#1 are matched with each other (step S32). If so, the control terminal 30 adjusts the position slider to a common level (step S35), and terminates the process of FIG. 16.

If the turn-on levels of all of the variable controllers 20A belonging to group#1 are not matched with each other (No of step S32), the control terminal 30 (the application 31) causes a user to select one unit serving as a reference (step S33), adjusts the position slider to the level of one representative unit (step S34), and terminates the process of FIG. 16. Due to this control, the group control and the individual control can be selectively carried out by the limited screen of the control terminal 30.

### (Modification)

The invention is not limited to the above embodiment, and it can be carried out in a modified way without departing from the spirit of the invention. For example, there are the following modifications such as (a) to (c).

(a) A gateway may be installed independently of the control terminal, and each of the LED lights 10 or the moving lights 120 may be controlled by scheduling or the like.

(b) The lighting appliance with which the lighting control system is provided is not limited to the LED light source, and may be, but not limited to, an arbitrary type such as an organic electroluminescence (EL), an inorganic EL, a fluorescent light, an incandescent electric light, or the like.

(c) The wireless mesh network of the invention is not limited to the CSRmesh (registered trademark), and may be, but not limited to, an arbitrary type.

According to the present invention, a lighting system or an apparatus control system that has high expandability can be easily constructed.

What is claimed is:

1. A dimmer comprising:
a reception unit that performs communication through a wireless mesh network;
a signal analysis unit that extracts PWM information based on a dimming instruction signal received by the reception unit;
a PWM instruction signal generation unit that generates a PWM instruction signal based on the PWM information; and
a PWM signal generation unit that generates a PWM signal for modulating brightness of a light source according to the PWM instruction signal.

2. The dimmer according to claim 1,
wherein the PWM signal generation unit generates the PWM signal for modulating the brightness of the light source to emit light in a predetermined pattern when associated with a network by an association signal received by the reception unit.

3. The dimmer according to claim 1,
wherein the PWM signal generation unit generates the PWM signal for modulating the brightness of the light source to emit light in a predetermined pattern when disassociated from a network by a disassociation signal received by the reception unit.

4. The dimmer according to claim 1,
wherein the PWM signal generation unit turns on the light source when associated with an external device by an association signal received by the reception unit, and turns off the light source when disassociated from the external device by a disassociation signal received by the reception unit.

5. A detector comprising:
a detection unit that detects environment information that is at least presence or absence of a human or ambient illuminance;
a signal generation unit that generates a dimming instruction signal for a dimmer modulating brightness of a light source based on the environment information; and
a transmission unit that performs communication on the dimmer through a wireless mesh network.

6. A lighting control system comprising:
a control device configured to include a transmission unit for transmitting a control signal through a wireless mesh network;
a plurality of dimmers configured to output a PWM signal based on the control signal; and
two or more lighting appliances operated to modulate brightness according to the PWM signal,
wherein the transmission unit selects one of the dimmers as a bridge device based on radio field strengths received from the plurality of dimmers, and communicates with the other dimmers via the one selected dimmer, and
wherein the transmission unit, when the radio field strength received from the one of the dimmers that is the bridge device is equal to or less than a predetermined value, re-selects another one of the dimmers as a bridge device based on the radio field strength received from each of the plurality of dimmers.

7. The lighting control system according to claim 6,
wherein the transmission unit transmits an association signal to the plurality of dimmers and sets the plurality of dimmers as a group to be controlled, and
wherein the lighting control system further comprises:
a display unit that displays a state of the group to be controlled in a disabled state or displays a state of any one of the dimmers of the group to be controlled when the states of the dimmers belonging to the group to be controlled are different from each other.

8. A controller comprising:
a reception unit that performs communication through a wireless mesh network;
a signal analysis unit that extracts control information based on a control instruction signal received by the reception unit;
an operation instruction signal generation unit that generates an operation instruction signal based on the control information; and
a drive signal generation unit that generates a drive signal for driving an apparatus according to the operation instruction signal.

9. The controller according to claim 8,
wherein the drive signal generation unit generates the drive signal for driving the apparatus to emit light in a predetermined pattern when associated with a network by an association signal received by the reception unit.

10. The controller according to claim 8,
wherein the drive signal generation unit generates the drive signal for driving the apparatus to emit light in a predetermined pattern when disassociated from a network by a disassociation signal received by the reception unit.

11. An apparatus control system comprising:
a control device configured to include a transmission unit for transmitting a control signal through a wireless mesh network;
a plurality of controllers configured to output a drive signal based on the control signal; and
two or more apparatuses that operates in accordance with the drive signal,
wherein the transmission unit selects one of the controllers as a bridge device based on radio field strengths received from the plurality of controllers, and communicates with the other controllers via the one selected controller, and
wherein the transmission unit, when the radio field strength received from the one of the controllers that is the bridge device is equal to or less than a predetermined value, re-selects another one of the controllers as a bridge device based on the radio field strengths received from the plurality of controllers.

12. The apparatus control system according to claim 11,
wherein the transmission unit transmits an association signal to the plurality of controllers and sets the plurality of controllers as a group to be controlled, and
wherein the apparatus control system further comprises:
a display unit that displays a state of the group to be controlled in a disabled state or displays a state of any one of the controllers of the group to be controlled when the states of the controllers belonging to the group to be controlled are different from each other.
